(19) United States
(12) Patent Application Publication
(10) Pub. No.: US 2013/0087119 A1
(43) Pub. Date: Apr. 11, 2013

(54) ENGINE CYLINDER AND INTERNAL COMBUSTION ENGINE HAVING THE ENGINE CYLINDER

(71) Applicant: MAHLE KOENIG KOMMANDITGESELLSCHAFT, Rankweil (AT)

(72) Inventor: FRANZ LAIMBOECK, GOLETA, CA (US)

(73) Assignee: MAHLE KOENIG KOMMANDITGESELLSCHAFT GMBH & CO. KG, RANKWEIL (AT)

(21) Appl. No.: 13/645,711

(22) Filed: Oct. 5, 2012

Related U.S. Application Data
(60) Provisional application No. 61/543,387, filed on Oct. 5, 2011.

(51) Int. Cl. F02F 1/00; F02M 25/07; F02M 57/00; F02M 69/04

(52) U.S. Cl. 123/297; 123/193.3; 123/445; 123/568.14

(57) ABSTRACT

An engine cylinder has a feed duct and a charge movement duct, which are each led adjacent to one another to an inlet valve in the cylinder head of the engine cylinder. A through flow of the two ducts is regulated by a common throttle valve extending in the or over the two ducts or their inflow openings, with which the end portions of the two ducts remote from the combustion chamber or their inflow openings can be closed.

### CROSS-REFERENCE TO RELATED APPLICATION

This application claims the benefit, under 35 U.S.C. §119(e), of provisional patent application No. 61/543,387 filed Oct. 5, 2011; the prior application is herewith incorporated by reference in its entirety.

### BACKGROUND OF THE INVENTION

### Field of the Invention

The invention relates to an engine cylinder with a feed duct and a charge movement duct which are each led adjacent to one another to an inlet valve in the cylinder head of the engine cylinder.

An inlet duct arrangement is known from Austrian Utility Model AT 005488 U1, wherein the inlet duct, but not the ducts feeding or continuing the inlet duct to two inlet valves, can be closed by a throttle valve.

Engine cylinders are also known, in which the flow through the feed duct and through the charge motion channel is regulated by a slider. However, the slider has disadvantages as a result of the pressures arising in these ducts and cannot regulate the through flow efficiently.

### SUMMARY OF THE INVENTION

The object of the invention is the manufacture of a simply constructed engine cylinder that can be regulated well in operation and to an inlet duct arrangement of an engine cylinder, with which the correct charge movements for the respective operating state can be produced in a controlled manner.

According to the invention, an engine cylinder of the type mentioned above is characterized by the features mentioned in the characterizing part of the claims. According to the invention, it is thus provided that the flow through the two ducts is regulated by a common throttle valve extending in or over the two ducts or their inflow openings, with which the end portions of the two ducts or their inflow openings remote from the combustion chamber can be closed.

With such a configuration of the engine cylinder, the flow through the feed duct and through the charge movement duct can be regulated, especially depending on each other, and the pressures occurring on the throttle valve can be controlled. In addition, combustion is promoted.

A simple configuration of the throttle valve results if the throttle valve is a plate-shaped component, which is pivotably mounted in its central portion about a pivot axis extending between the two ducts and perpendicular to the through flow direction and/or if the throttle valve contains two portions, each of which lies in one of the two ducts and is pivotable about its pivot axis from a closed position transverse to the through flow direction into an open position parallel to the through flow direction. It is advantageous for regulation if the two portions of the throttle valve adjacent to the pivot axis or adjoining the two sides of the central region lie in the same plane and each protrudes into one of the two ducts and pivot movements are carried out in both ducts in the same direction of rotation.

It is of particular significance if it is provided that the inner wall surface of the output duct or the inflow duct in its portion—when viewed in the through flow direction—lying immediately before the throttle valve contains a toroidal formation, which is adapted to the spatial region wiped by the portion of the throttle valve protruding into the feed duct during its pivotal motion. The torus extends over a pivot angle A of the throttle valve, where 0<A≦40°, preferably 0<A≦35°, and an angle A of 0° corresponds to the closed position of the throttle valve. The toroidal region extends upstream or outside the feed duct approximately over half the circumference of the inlet duct.

With the torus it is achieved that one of the two ducts that continues the output duct, i.e. the feed duct, remains closed in the event of pivoting of the throttle valve starting from its closed position into its open position through a predefined pivot angle of the throttle valve, whereas the charge movement duct is already successively opened. With this configuration, it is achieved that a slow combustion under partial load is accelerated by combustion with higher flow speeds and the resulting greater charge movement and turbulence. In the case of high loads, the dissipative flow speed and the turbulence resulting therefrom in the cylinder can be reduced, in particular by increased inflows of fresh gas via the feed duct, so that the charge movement occurring in the combustion chamber, which arises from the inflow of fresh gas through the charge movement duct, is reduced. For this purpose, the provided throttle valve is arranged as close as possible to or relatively close to the inlet valves for closing the feed duct and the charge movement duct. The distance of the throttle valve from the valves is not greater than two to three times the greatest extent or dimension or the longer axis of the throttle valve.

It is important for the formation of a charge movement for promoting partial load combustion within the combustion chamber that the feed duct remains closed until the charge movement duct has achieved a certain minimum opening cross section. This is achieved by the provided pivot angle, via which the throttle valve is still in close contact with the inner wall surface of the feed duct or comes very close to the torus and prevents flow through the feed duct as far as possible. After the throttle valve has exceeded the maximum pivot angle A resulting from the toroidal formation of the inner wall surface, fresh gas flows into the combustion chamber through both ducts.

A simple configuration and good control behavior result, if the portion of the inner wall surface with the toroidal shape and the throttle valve are formed symmetrically relative to a plane perpendicular to the pivot axis of the throttle valve and/or the throttle valve is symmetrical to a plane containing the pivot axis and/or if the toroidal inner wall surface of the output duct and the peripheral surface of the portion of the throttle valve that is adapted to the inner wall surface run close together over the range of the pivot angle and/or if the wall portion with the toroidal inner wall surface represents a bulge in the wall of the output duct.

It also advantageous if an injection unit is arranged in the cylinder head, whose spraying direction passes through the valve for closing the charge movement duct into the combustion chamber of the engine cylinder, wherein the spraying direction of this injection unit passes through the valve gap formed between the valve seat and the valve plate. Fuel is thus injected into the supplied fresh gas with suitable turbulence, so that by the turbulences arising, optimal mixture formation and homogenization of the injected fuel with the supplied fresh gas are achieved.

For combustion optimization, it is also provided that one or more idle tubes or idle air ducts, which is (are) skewed relative to the axis of the valve and aligned to the valve gap of the open valve, protrude(s) or open(s) into the charge movement duct in the region between the throttle valve and the inlet valve, the one or more tubes or ducts preferably having an inflow direction tangential to the cylinder bore and being advantageously directed towards the wall region of the cylinder bore, which is close to the valve seat of the valve.

It is of advantage for the control response or for the formation of the torus if the peripheral region of the portion of the throttle valve for closing the ducts, this portion being disposed remotely from the pivot axis or adjacent to the rectangular central portion, is rounded, in particular elliptically or circularly rounded or semi-circularly, semi-elliptically or semi-ovally shaped.

In order to achieve suitable sealing of the through flow cross sections of the feed duct and of the charge movement duct, it is provided that the throttle valve, when in its closed position, is in contact with or lies very close to the wall surface formed by the charge movement duct and the feed duct over its entire circumference or at least the entire circumference of said portion.

It is advantageous for the ignition of the fuel-air mixture if at least one ignition unit is disposed in the cylinder head so as to project into the combustion chamber.

According to the invention, it is provided that the separating wall formed between the mutually adjacent ducts extends from the portion of the ducts close to the cylinder, and disposed between adjacent valves or valve seats, to the bore or bearing of the pivot axis of the throttle valve.

Separation of the feed duct and of the charge movement duct thus takes place in the portion between the valves and the throttle valve. Mutually separate air regulation can take place in the two ducts, without regulation in one channel that takes place with the throttle valve and/or the idle tube and/or the injection unit having a direct influence on the regulation in the other channel. For this purpose it is especially useful if the dividing wall, in its end portion remote from the cylinder, is disposed adjacent to or immediately collocated with the pivot axis or that the pivot axis is supported in the end portion of the pivot axis.

It is advantageous for the structural configuration and the flow properties of the feed duct and of the charge movement duct if the throttle valve is formed by an oval plate or if the throttle valve is formed by a plate having a rectangular or square central portion, adjoined on each opposing side by a portion formed by a semi-circle, by a semi-ellipse or by a half-oval.

In particular in the case of such a configuration, in order to achieve optimal flow conditions it can be advantageously provided that the inner wall surfaces of the ducts and/or the inner wall of the induction duct close to the throttle valve, apart from the formation, have parallel generatrices in each case individually and/or relative to one another.

It is advantageous for the configuration of the throttle valve if the pivot axis extends along the shorter central axis of the throttle valve and/or perpendicular to the free sides of the central portion and/or parallel to the plane of the dividing wall and is aligned perpendicular to the longitudinal extent in the portion close to the pivot axis.

It is advantageous structurally and for the control response if the throttle valve, in its closed and/or idle position or in its position for the lowest partial load, tightly seals the two ducts closed and/or if supporting steps for peripheral portions, preferably for the entire peripheral portion, of the throttle valve are formed in the initial portions, being close to the throttle, of the two ducts extending along the circumference of the inlet duct.

A favorable control range for the supplied combustion air or for the formation of a fuel-combustion mixture is achieved if the toroidal formation of the inner wall surface extends over an angular range of no greater than 40°, preferably no greater than 35°, starting from the plane defined by the closed position of the throttle valve, wherein the apex of the angle lies on the pivot axis.

The size of the throttle valve and thus of the feed duct and of the charge movement duct or of the intake duct is thus dimensioned in such a way that the longitudinal axis of the throttle valve corresponds to the maximum overall extent of the valve openings of the valves of the ducts, possibly increased by no more than 10%, and the transverse axis of the throttle valve corresponds to the internal diameter of a valve seat ring, possibly increased by no more than 10%.

It was found that it improves the mixing and combustion behavior if the opening of the idle air duct into the charge movement duct is formed between the throttle valve and the valve seat ring in a region from 0 to 35%, preferably 0 to 30%, of this distance above the valve seat ring and is preferably carried through to the valve seat ring on the cylinder side or is in contact with the valve seat ring.

This property of the engine cylinder is also improved if the injection unit opening into the charge movement duct contains a fan nozzle, with which fuel is injected in a fan shape through the valve gap of the valve for closing the charge movement duct into the cylinder in a region being disposed underneath the ignition unit arranged in the cylinder head in the central portion of the cylinder bore and/or the plane of injection of the fan-shaped fuel jet is intersected by the stream of combustion air flowing in through the idle air duct.

It is also favorable for combustion and mixture formation if the injection unit is arranged in or opens into the charge movement duct between the closed throttle valve and the valve seat ring in a region from 5 to 30%, preferably 10 to 20% of this distance above the valve seat ring.

As already mentioned, it is thus advantageous for the mixture formation and combustion if an idle air regulator is connected upstream of the idle air duct and if only one idle air duct is provided or formed for each cylinder and/or a fuel injection unit remote from the cylinder opens into the induction duct, with which fuel can be injected under control into the initial portions of the feed duct and/or the charge movement duct in proximity to the throttle.

It is advantageous for the mixture formation if the idle air regulator, with the throttle valve open at an angle from 30 to 90°, adjusts the flow through the mouth of the idle air channel to a predefined, minimal, non-zero through flow value.

The invention also relates to an externally ignited internal combustion engine with at least one engine cylinder configured according to the invention.

Other features which are considered as characteristic for the invention are set forth in the appended claims.

Although the invention is illustrated and described herein as embodied in an engine cylinder and internal combustion engine having the engine cylinder, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIGS. 1, 2 and 3 are diagrammatic, perspective views of an engine cylinder with an inlet duct arrangement and the arrangement of a feed duct 2 and a charge movement duct 3 with a common throttle valve 6, which lead from an inlet duct 30 to a cylinder head 4 of the engine cylinder 1 which is not explicitly shown for reasons of clarity. The throttle valve 6 is in the blocking position in FIG. 1, in FIG. 2 in the partly open position and in FIG. 3 in the fully open position.

FIGS. 4, 5 and 6 are diagrammatic, perspective views showing comparable illustrations, wherein an injection unit 14 for fuel is also illustrated.

FIG. 7 is a diagrammatic, perspective view showing an illustration similar to FIGS. 1 and 4, wherein exhaust gas recirculation lines 16 and an idle tube 17 are illustrated.

FIG. 8 is a diagrammatic, perspective view showing a view of the feed duct 2 and charge movement duct 3 that are led to the cylinder head, wherein the position of the valves 5 for closing these two ducts 2, 3 can be seen.

FIG. 9 is a diagrammatic, perspective view showing an open cylinder head with a throttle valve 6 being in the closed position.

FIG. 10 is a diagrammatic, perspective view showing a view according to FIG. 9 with the throttle valve 6 opened by 30°.

FIG. 11 is a diagrammatic, perspective view showing the throttle valve 6 opened by 55°.

FIG. 12 is a diagrammatic, perspective view showing a view according to FIG. 11 with a fully opened throttle valve 6.

FIG. 13 is a diagrammatic, perspective view showing a close-up view of the throttle valve 6.

### DETAILED DESCRIPTION OF THE INVENTION

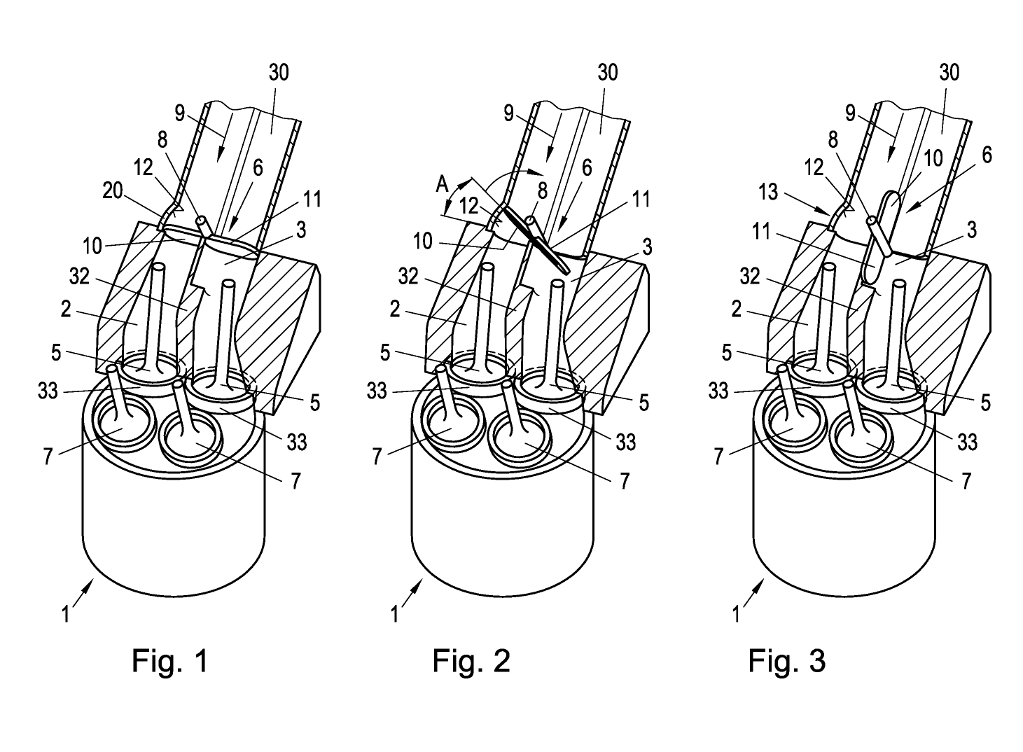

Referring now to the figures of the drawing in detail and first, particularly, to FIG. 1 thereof, there is shown a schematic view of an engine cylinder 1, in or on which are formed, or to which are connected, a cylinder head 4, a feed duct 2 and a charge movement duct 3, which are not illustrated for reasons of clarity. The feed duct 2 and the charge movement duct 3 are each led to a valve seat 33 of an inlet valve 5, which valves 5 close or open the combustion chamber relative to the ducts 2, 3. A throttle valve 6 can simultaneously close both the feed duct 2 and also the charge movement duct 3, as is illustrated in FIG. 1, and thus regulate the flow through the ducts 2, 3. The exhaust gases arising in the combustion chamber are carried out of the combustion chamber via exhaust valves 7.

In this and in the other figures, only the essential components of the engine cylinder 1 or an internal combustion engine are illustrated. Valve controllers or devices for controlling or pivoting the throttle valve 6 are not illustrated. For this purpose, devices are used that are familiar to one of skill in the art.

In FIG. 1 can be seen the ducts 2, 3 that are led adjacent to one another and in which flow is taking place in the direction of arrow 9. The throttle valve 6 contains two portions 10 and 11 adjacent to a central portion 34, wherein in common with the central portion 34 the portion 10 can close or open the feed duct 2 and the portion 11 can close or open the charge movement duct 3.

In the portion of the inlet duct 30, which is disposed upstream of the feed duct 2 or upstream of the throttle valve 6 in its closed position, a toroidal inner wall surface 12 is formed, which is adapted to the surface area wiped by the circumference of the portion 10 during its pivoting movement about the pivot axis 8, and along which the circumference of the portion 10 moves in the direction of the arrow 18 during a pivotal motion of this portion 10. This close or very close sliding along motion takes place over a pivot angle A, as illustrated in FIG. 2. The through flow cross section of the feed duct 2 is opened only after exceeding the pivot angle A. A toroidal formation 13 of the inner wall surface 12 extends over a pivot angle A of no greater than 40°, preferably of no greater than 35°.

The opening of the feed duct 2 thus takes place during pivoting of the throttle valve 6 into the open position at a later point in time than the opening of the charge movement duct 3, so that the flow through the two ducts 2, 3 starts at different positions of the throttle valve 6 and thereby the quantities of fresh gas fed through the valves 5 into the combustion chamber influence the combustion correspondingly differently.

In FIG. 3 the throttle valve 6 is shown in its fully open position, i.e.

parallel to the through flow direction 9 of the ducts 2 and 3.

The throttle valve 6 is formed of a plate-shaped component, which in its central portion 34 is mounted so as to pivot about a pivot axis 8 extending between the two ducts 2, 3 and perpendicular to the through flow direction 9. The throttle valve 6 is pivotable about the pivot axis 8 from a closed position transverse to the through flow direction 9 into an open position parallel to the through flow direction 9, as illustrated in FIGS. 1 and 3.

The movement of the portions 10, 11 is rigidly coupled. The portion immediately before the throttle valve 6 on the inner wall surface 12 of the feed duct 2—looking in the through flow direction 9—contains the toroidal formation 13, so that the outer periphery of the portion 10 of the throttle valve 6 projecting into or closing the feed duct 2 during its pivotal motion through the predefined pivot angle A from the closed position to the open position always remains in close contact with or in close proximity to the toroidal formation 13 of the inner wall surface 12.

The portion of the inner wall surface 12 and the throttle valve 6 are formed symmetrically relative to a central plane perpendicular to the pivot axis 8 of the throttle valve 6, just as the throttle valve 6 is formed symmetrically relative to a plane containing the pivot axis 8. The toroidal portion or the toroidal formation 13 and the peripheral surface of the portion 10 of the throttle valve 6 adapted to the inner wall surface 12 are led close to one another over the range of the pivot angle A.

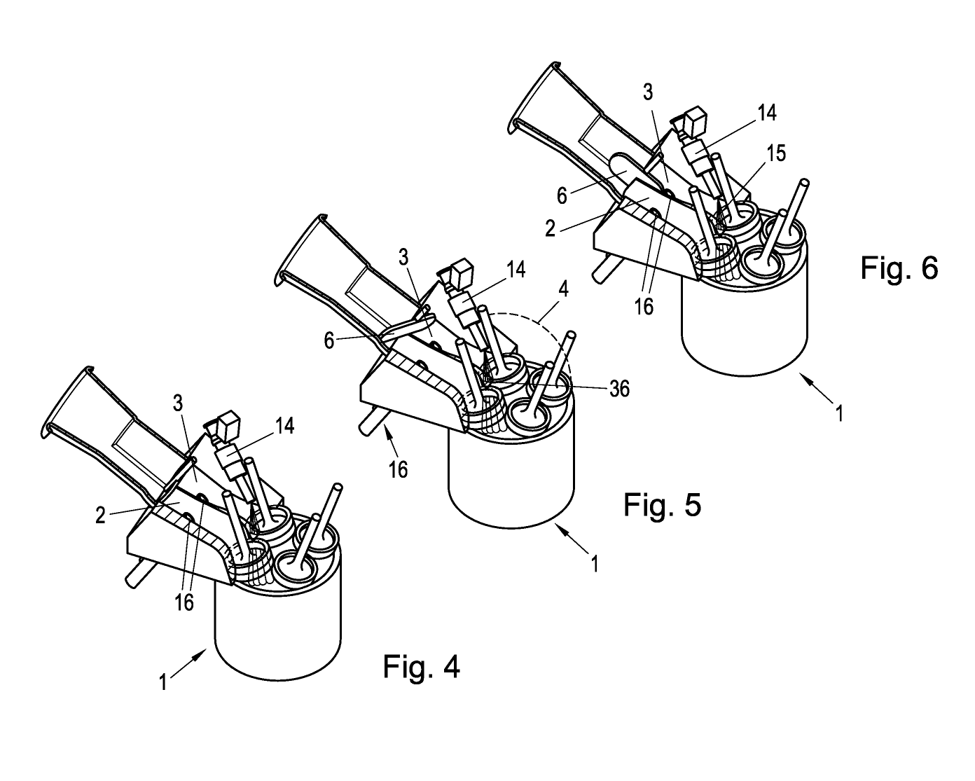

FIGS. 4, 5 and 6 essentially correspond in respect of the configuration of the engine cylinder 1 to FIGS. 1, 2 and 3, wherein, however, an injection unit 14 is illustrated, which is arranged in the cylinder head 4, which is only schematically indicated in FIG. 5. The injection unit 14 is formed in such a way that its spraying direction 15 passes through a valve gap 36 of the valve 5 in the combustion chamber of the engine cylinder 1 for closing the charge movement duct 3. The spraying direction 15 extends through the valve gap 36 when the valve 5 is open. This results in optimal turbulence of the injected fuel with the supplied fresh gas with minimal wall adhesion of fuel in the inlet duct 30 or in the charge movement duct 3.

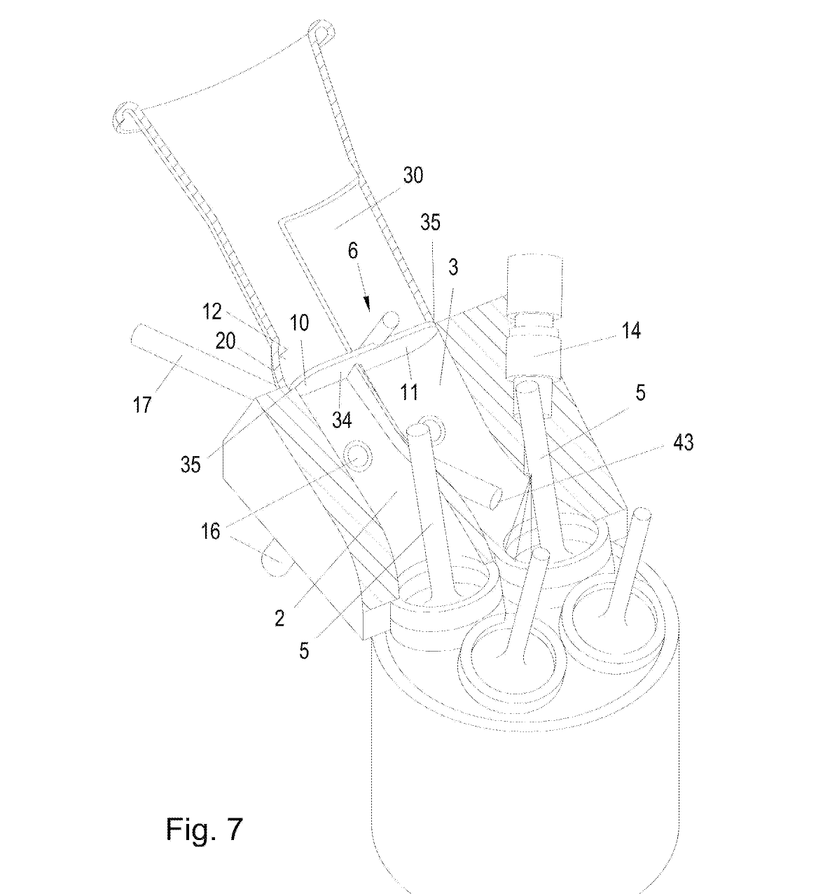

In accordance with FIG. 7, exhaust gas recirculation ducts 16 open in the feed duct 2 and in the charge movement duct 3 between the throttle valve 6 and the valves 5, whereby the combustion in the combustion chamber can be positively influenced and charge exchange losses can be reduced.

An idle tube or idle air duct 17 opens in the charge movement duct 3 in the portion between the throttle valve 6 and the inlet valve 5, which runs skewed relative to the axis of the valve 5 and is oriented at an angle to the valve gap 36 of the valve 5 for closing the charge movement duct 3, extending in a predominantly tangential inflow direction to the cylinder bore in order to achieve maximum charge movement in the cylinder.

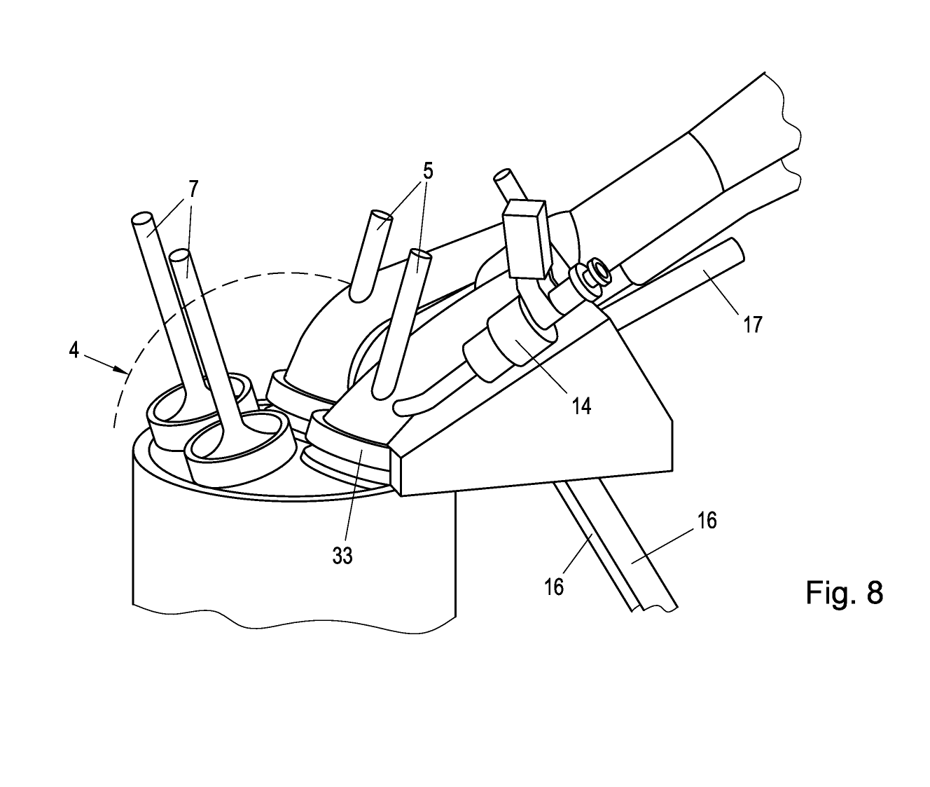

FIG. 8 shows an external view of the engine cylinder 1 according to the invention with a cylinder head 4 that is only indicated. The pipelines bounding the feed duct 2 and the charge movement duct 3 can be seen, as well as the injection unit 14, the exhaust gas recirculation ducts 16 and the idle tube 17. Instead of the idle tube 17 there can be a bore of an idle air duct which is oriented in the same direction.

An ignition unit, which is required for the combustion of the fuel-air-mixture, is not illustrated in FIGS. 1 to 8 for clarity reasons and is generally disposed centrally between the provided valves 5, 7. In principal, multiple ignition units can also be provided.

With the throttle valve 6 in the closed position, i.e., for a pivot angle A of 0°, the feed duct 2 and the charge movement duct 3 are closed; air induction takes place via the idle tube 17. For a throttle valve 6 position at a pivot angle A of approximately 30°, the feed duct 2 always remains closed and the charge movement duct 3 is partially open. Similarly as for the closed throttle valve 6, fresh gas supplied off-center or tangentially generates strong spin, and good mixing of the fresh gas with the injected fuel and a high degree of turbulence occur in the combustion chamber, so that rapid and stable combustion takes place. For the exemplary open position of the throttle valve 6 illustrated in FIG. 6 for full load or for a fully open through flow cross section of the feed duct 2 and of the charge movement duct 3, an optimal flow speed and maximally turbulent kinetic energy in the cylinder chamber result, so that the combustion takes place in an optimally rapid and stable manner. By recirculation of the exhaust gases via the exhaust gas recirculation ducts 16, the combustion can be adjusted or adapted to the desired engine operating conditions.

The injection unit 14 sprays a jet of fuel with the spraying direction 15 through the valve gap 36 into the combustion chamber, wherein the droplet diameter is generally a diameter of approximately 20 μm SMD (Sauter mean diameter). A good mixture formation, low cylinder wall moistening, stable combustion and low emission values are thus achieved.

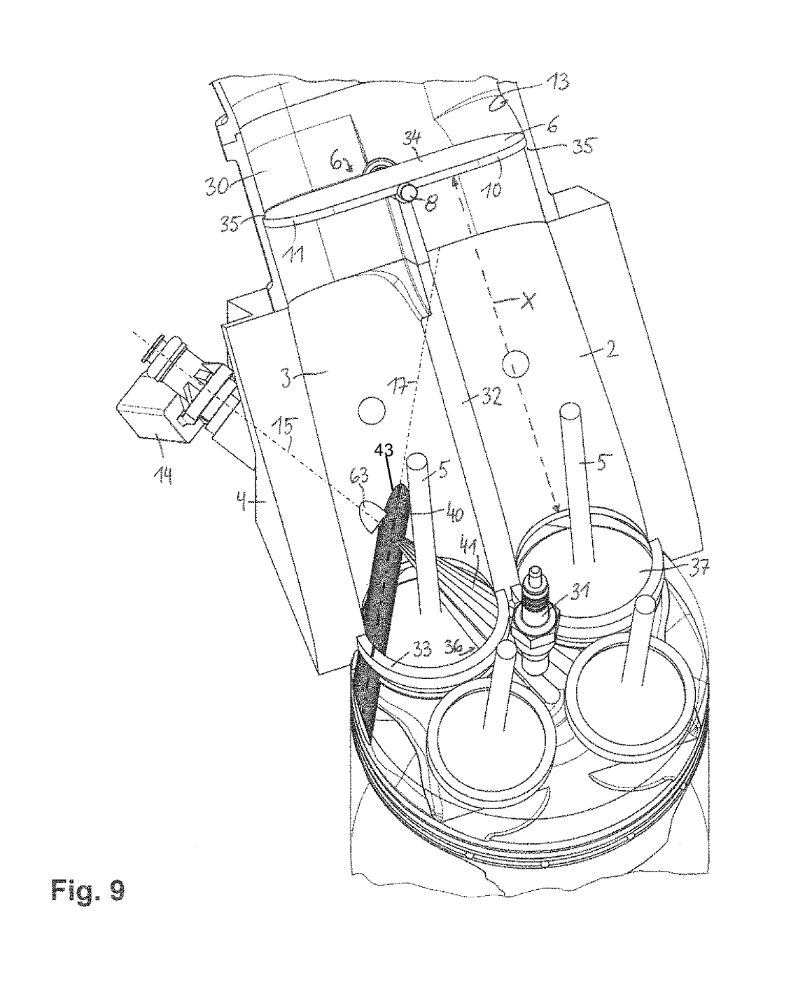

FIG. 9 shows a schematic view of an engine cylinder according to the invention with an open cylinder head or sectional induction or inlet line 30. The throttle valve 6 has a pivot angle of 0°, which means that the throttle valve 6 is closed tight and the peripheral regions of portions 10 and 11 and of the central portion 34 of the throttle valve 6 are immediately close to peripheral steps 35, which are formed in the inlet duct 30 or the end portions of the ducts 2, 3. This view reproduces the condition during idling or for very low partial load. Not illustrated is an idle regulator, which regulates the air flow passing through the idle air duct 17 using pulse width modulation. An air jet 40 enters the charge movement duct 3 through an opening 43 of the idle tube 17, enters the combustion chamber through the valve gap 36 between the valve 5 and the valve seat 33 and impinges on the wall of the cylinder bore in the tangential direction and thus generates strong spin and a strong tumbling motion in the combustion chamber.

It can also be seen that the fan-shaped fuel jets 41 emitted by a fan nozzle 63 of the injection unit 14 cross the air jet 40, which flows in through the mouth 43 of the idle air duct 17. The fan-shaped fuel jets 41 pass into the combustion chamber through the valve gap 36 and pass into the combustion chamber underneath an ignition unit 31. In this load range, which is provided for idle and very low partial load, the throttle valve 6 is tightly closed and fresh charge only flows in via the idle tube 17 and generates strong spin combined with a strong tumbling motion, i.e. charge motion, in the combustion chamber. The fuel jets 41 and the idle air jet 40 provide good mixture formation and excellent combustion stability, whereby the mass of air is regulated by the idle regulator (not illustrated), for which purpose the control loop takes into account the engine revolution rate and finally allows a reduction of the idle revolution rate, which results in improved efficiency and consumption.

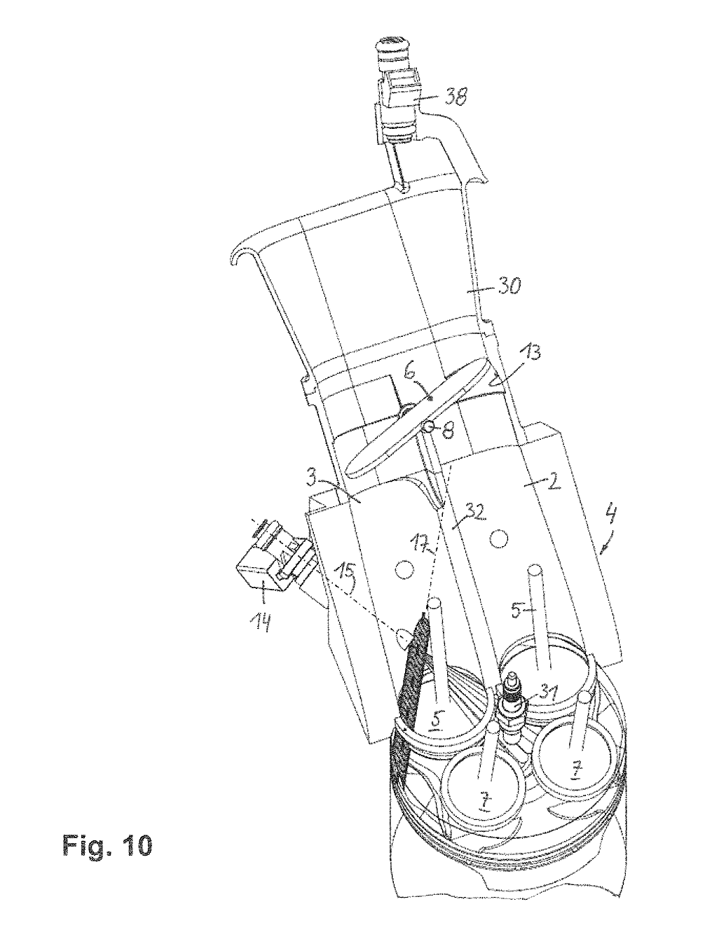

FIG. 10 shows the arrangement according to FIG. 9 for a throttle valve position with a pivot angle A of approximately 30°. As a result of the formation 13 of the inner wall surface of the inlet duct 30 in the form of a torus adapted to the throttle valve 6, the feed duct 2 remains closed, whereas the charge movement duct is already partly open to incoming flow. This position of the throttle valve 6 exists for low to medium partial load. A dividing wall 32 possibly representing a plane of symmetry for the ducts 2, 3 lies in the center between the two ducts 2 and 3 and strictly separates these ducts 2, 3 and is led from the valve seats 33 upstream to the throttle valve 6 or its pivot axis 8, so that the passage of gases from the one duct into the other duct cannot occur. In this position of the throttle valve the idle air duct 17 is still open and the fuel injection takes place via the injection unit 14 close to the engine, whose fuel jets 41 cross the air flowing in through the charge movement duct 3 and the throttle valve 6 that is partly opening this channel 3. The combustion efficiency is thus increased and the combustion is accelerated, whereby a high torque and a good response are achieved and a rapid take-up of gas takes place during acceleration.

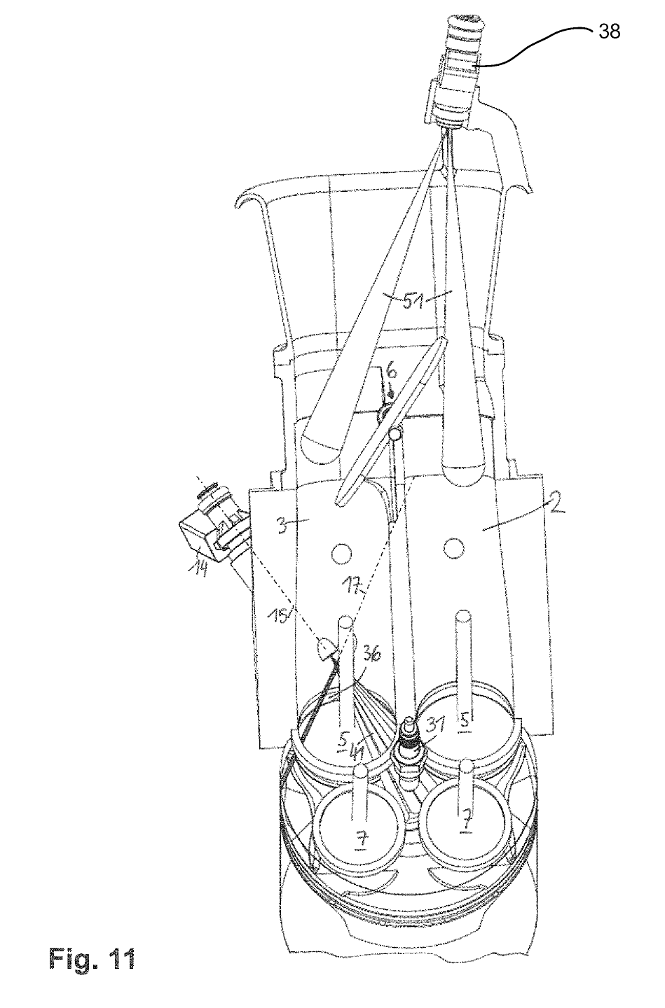

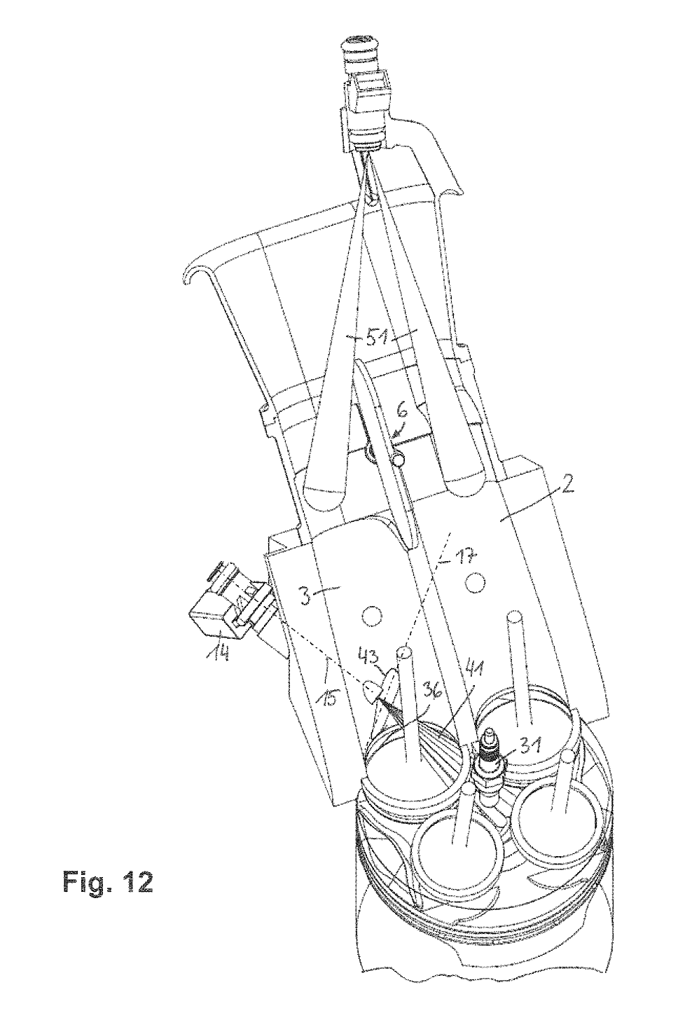

FIGS. 11 and 12 show the views according to FIGS. 9 and 10 for a position of the throttle valve for a pivot angle A=55° (FIG. 11) and a pivot angle A=90° (FIG. 12).

FIG. 11 and FIG. 12 show a remote nozzle or further injection unit 38, with which fuel jets 51 can be injected into the portion of the feed duct 2 and of the charge movement duct 3 close to the throttle. In this load region, which is defined by pivot angle A of 55° to 90°, the two ducts 2, 3 are opened. The fan-shaped fuel jets 41 are emitted by the injection unit 14 and through the valve gap 36 towards the region underneath the ignition unit 31. In addition, as required, a certain quantity of idle air can flow into the valve gap 36 and be intersected by the fuel jets 41, whereby the mixture formation is improved and a collection of fuel in the idle air duct 17 can be avoided. This means that over the entire load range or over the entire possible pivot angle range of the throttle valve 6, air can be flowed in under the control of the idle air regulator. Also, for the position of the throttle valve 6 at full opening illustrated in FIG. 12, idle air can be flowed in through the opening 43 in order to avoid reverse flow of fuel in the idle air duct 17.

In this load region of the throttle valve, which is defined by a pivot angle of approximately 55° to 90°, the throttle valve 6 has freed or opened the two ducts 2, 3. The flow in these ducts 2, 3 is concentrated on the outer edge or the wall region of these ducts 2, 3 and an ideal spin and tumbling charge movement takes place in the combustion chamber. As a result of the inflow in the outer region and a parallel feed of the inlet ducts 2, 3, the formation of an unwanted omega tumble does not occur. A residual feed of idle air and an additional injection of fuel by the injection unit 38 provide the required fuel quantity in a distinctly short time, so that the injection time can be reduced.

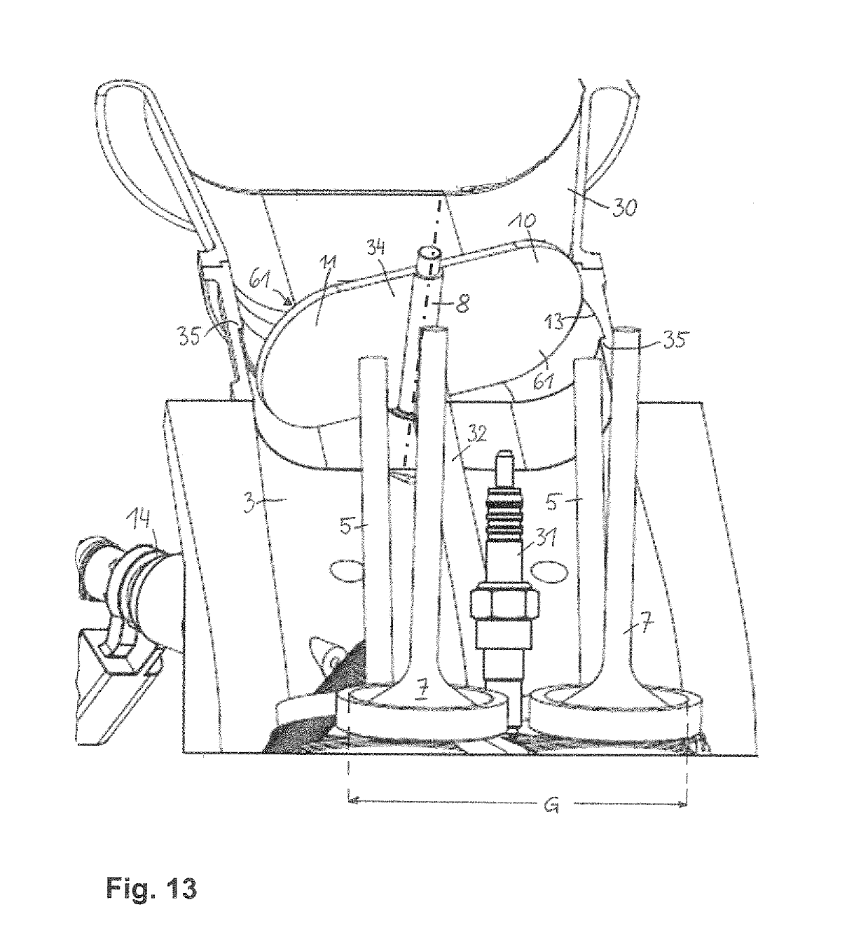

FIG. 13 shows an enlarged view of the throttle valve 6. It can be seen that the pivot axis 8 of the throttle valve 6 extends over the short side of the central section or central portion 34 of the throttle valve 6 carried by the pivot axis 8, which central portion 34 is in the form of a rectangle. It is provided that the peripheral portions 11 of the portions 10, 11 of the throttle valve 6 for closing the ducts 2, 3 and located remotely from the pivot axis 8 are rounded, in particular semi-elliptically or semi-circularly or half-ovally rounded.

It is also provided that the throttle valve 6 in its closed position, at least over partial portions of its circumference, preferably over its entire circumference or the entire circumference 61 of the portions 10, 11, is in contact with the wall surfaces formed by the charge movement duct 3 and the feed duct 2, preferably in a gas-tight manner.

The dividing wall 32, which is only indicated in FIG. 13, locks tightly to the pivot axis in its end portion. It is also provided that the throttle valve 6 is formed by a plate, which contains a rectangular or square central portion 34, being adjoined on opposite sides in each case to a portion 10, 11 formed by a semicircle or by a semi-ellipse or by a half-oval.

It is further provided that the pivot axis 8 extends along the shorter central axis of the throttle valve 6 and/or extends perpendicularly to the exposed sides of the central portion 34 and/or is aligned parallel to the plane of the dividing wall 32 and perpendicular to its longitudinal extent in its portion close to the pivot axis.

It can be seen from FIG. 13 that the peripheral region of portion 10 describes a toroidal spatial area while pivoting about the pivot axis 8. Portion 10 of the throttle valve 6 moves along the portion 13 with a toroidal shape, which is formed in the inner wall surface of the inlet duct 30.

The arrangement of the throttle valve 6 with the rectangular or square central portion 34 and adjoining semicircular, semi-elliptical or half-oval portions 10 or 11 allows that the internal wall surfaces of the ducts 2, 3 and/or the inner wall of the induction duct 30 in proximity to the throttle valve 6, excluding the formation 13, contain respectively internally parallel generatrices and/or mutually parallel generatrices. The ducts 2, 3 or 30 can thus be led up to the respective valve seat 33 with parallel duct edging, by which the through flow values are improved and abrupt transitions with small radii are avoided.

By the initial unilateral opening of the ducts or opening, i.e. only opening the charge movement duct 3 over a pivot angle of 0 to e.g. 35°, a corresponding charge movement takes place through the tangentially inflowing idle air as a result of the induction-synchronized injected mixture cloud or the fan-shaped injected fuel jets 41, so that the mixture cloud in the combustion chamber is moved down. With the throttle valve 6 open, an optimal tumbling charge movement occurs in a pivot angle region of 50° to 90° in the combustion chamber with a tumble number of circa 0.7.

The throttle valve 6, when in its closed position, has its longitudinal axis approximately parallel to the line joining the central point of the valves 5 for closing the feed duct 2 and the charge movement duct 3 on the combustion chamber side. Because in addition the pivot axis runs perpendicular to the longitudinal direction of the throttle valve 6 or this connecting line of the valves 5 or the valve seats 33, a minimal blockage of the inlet duct 30 or the ducts 2, 3 is caused by the throttle valve 6 in the open position of the throttle valve 6. It is shown to be advantageous if the longitudinal axis of the throttle valve 6 corresponds to the maximum overall extent G of the valve openings of the valves 5 of the ducts 2, 3, possibly increased by no more than 10%, and the transverse axis of the throttle valve 6 corresponds to the internal diameter of a valve seat ring 33, possibly increased by no more than 10%.

The inlet duct 30 or the ducts 2, 3 with parallel extending generatrices can be made larger than known A-shaped inlet ducts, which provide round throttle valves. In principle, combustion under partial load would be degraded by a larger duct cross section; such a degradation would, however, be more than compensated according to the invention in a range of 0° to approximately 35° of the pivot angle by masking of the feed duct 2, i.e. by blocking the feed duct 2, so that both a better partial load response and also a higher peak performance result.

Such an improvement is also achieved with an oval throttle valve, whose peripheral shape deviates only slightly from the throttle valve exhibiting the best results with a rectangular central portion 34 and adjoining semicircular or elliptical portions 10 and 11. A performance improvement is also achieved with oval shaped throttle valves, in particular by masking or closing the feed duct 2 in the pivot angle range of 0 to 35°.

The upper limit value for the pivot angle up to which a masking or a closure of the feed duct 2 occurs, is selectable in certain regions and depends in particular on the type of construction, size, shape and load conditions of the cylinder.

It has been shown that it is advantageous for the combustion if the opening 43 of the idle air duct 17 has an area greater by 50 to 100% than the area of openings of idle air channels for cylinders of equal volume and/or equal performance. The selection of the area is simple to carry out, as detailed below.

For example, if a naturally aspirated engine with a cylinder volume of Vh=1200 cm³ has an indicated idling power at a revolution rate n of approximately 0.8 kW; this is the power required to overcome frictional losses. The Friction Mean Effective Pressure FMEP is approximately 0.9 bar for a revolution rate of 900 rpm. The power P=FMEP•Vh•n/1200=0.9•1.2·900/1200=0.81 kW.

With an indicated idling load of approximately 800 g/kWh, a fuel consumption of B=800×0.81=648 g/h=648/3600=0.18 g/s results. With a fuel/air ratio of approximately 1 and a stoichiometric fuel/air ratio of 14.75 kgAir/kgFuel, the air consumption BAir=0.18•1•14.75=2.66 gAir/s for an air density of 1.167 kg/m³ and a volumetric air flow of 2.66/1.167•1000=0.00227 m³/s.

For a target air speed in the idle tube of approximately 50 m/s, a cross section of 0.002275/50=0.000455 m²=45.5 mm² is necessary.

This idle tube bore cross-sectional area is distributed among all cylinders, so that e.g. a 2-cylinder engine has an idle bore of 22.7 mm², corresponding to a circle diameter of 5.4 mm diameter per cylinder.

With the engine cylinder according to the invention, it is intended to provide an idle cross section that is greater by 50% to 100%, which yields for the above example an idle air bore of 34 mm² to 45.5 mm² and a corresponding circle diameter of 6.6 mm to 7.6 mm.

It is advantageous for the useful function of the larger idle bore to support the charge movement and mixture formation in the lower partial load to have a high resolution, rapid air volume control, which is preferably driven by a control valve with PWM (Pulse Width Modulation) and which uses as control parameters the output signal of the lambda probe in the exhaust and the idle revolution rate.

The air fed with a high flow rate of 50 m/sec into the idle pipe crosses the fan-shaped injection jet 41 close to the engine and provides for excellent mixture formation and homogenization.

Especially in the low load regions, naturally aspirated injection engines usually have poor mixture formation and homogenization, so that in most cases induction synchronous injection is not possible, because then there is not the time for mixture formation.

1. An engine cylinder, comprising:
a cylinder head having a combustion chamber;
an inlet valve disposed in said cylinder head;
a common throttle valve; and
two ducts including a feed duct and a charge movement duct running adjacent to said feed duct to said inlet valve in said cylinder head of the engine cylinder, a through flow of said two ducts being regulated by said common throttle valve extending in or over said two ducts or in or over inflow openings of said two ducts, with which end portions of said two ducts remote from said combustion chamber or said inflow openings of said two ducts can be closed.

2. The engine cylinder according to claim 1, wherein said common throttle valve is a plate-shaped component having a central portion and is pivotably mounted via said central portion about a pivot axis and extending between said two ducts and perpendicular to a through flow direction of said two ducts.

3. The engine cylinder according to claim 1, wherein said common throttle valve contains a pivot axis, a central portion and two portions adjoining said central portion, each of said two portions is disposed in one of said ducts or each together with said central portion closes or projects into a channel, whereby said common throttle valve can pivot about said pivot axis from a closed position transverse to a through flow direction into an open position parallel to the through flow direction.

4. The engine cylinder according to claim 3, wherein said two portions of said common throttle valve are disposed adjacent to said pivot axis or adjoining two sides of said pivot axis, lie in a same plane and each of said two portions protrudes into one of said two ducts and carries out pivotal motions in a same rotation direction in both of said two ducts.

5. The engine cylinder according to claim 1, further comprising an induction duct having an inner wall surface in a portion disposed immediately before one of said common throttle valve or said feed duct—when viewed in a through flow direction—having a toroidal formation, which is adapted to a spatial area wiped by a periphery of a portion of said common throttle valve protruding into or closing said feed duct during a pivotal motion from an open position into a closed position, wherein a torus extends over an angular range or pivot angle A wiped by a edge portion of said common throttle valve during its displacement, and 0<A≦40°, and an angle A of 0° corresponds to the closed position of the throttle valve.

6. The engine cylinder according to claim 5, wherein said portion of said inner wall surface with said toroidal formation and said common throttle valve are formed symmetrically relative to a plane aligned perpendicularly relative to a pivot axis of said common throttle valve, and/or said common throttle valve and/or said ducts are formed symmetrically relative to a plane containing said pivot axis.

7. The engine cylinder according to claim 5, wherein said toroidal formation of said inner wall surface of said induction duct and a peripheral surface of a portion of said common throttle valve adapted to said inner wall surface are led very close together or close together over a range of said pivot angle A.

8. The engine cylinder according to claim 5, wherein a wall region with said toroidal formation of said inner wall surface represents a bulge of a wall of said induction duct.

9. The engine cylinder according to claim 1,
wherein said inlet valve has a value seat and a valve plate; and
further comprising an injection unit disposed in said cylinder head, and having an injection direction passing through said inlet valve for closing said charge movement duct into said combustion chamber of the engine cylinder, wherein the injection direction of said injection unit passes through a valve gap formed between said valve seat and said valve plate.

10. The engine cylinder according to claim 1, further comprising at least one exhaust gas recirculation duct opening into each of said feed duct and said charge movement duct in a region between said common throttle valve and said inlet valve.

11. The engine cylinder according to claim 1,
wherein said cylinder head has a cylinder bore formed therein defined by a wall region; and
further comprising an idle element, selected from the group consisting of an idle tube and an idle air duct, extending skewed relative to an axis of said inlet valve and aligned with a valve gap of an open valve, projects or opens into said charge movement duct in a portion between said common throttle valve and said inlet valve, which has an inflow direction tangential to said cylinder bore and is directed towards said wall region of said cylinder bore disposed close to a valve seat of said inlet valve.

12. The engine cylinder according to claim 1, wherein peripheral portions of portions of said common throttle valve for closing said two ducts that are remote from a pivot axis are rounded.

13. The engine cylinder according to claim 1, wherein said common throttle valve in a closed position, at least over partial portions of a circumference, contacts wall surfaces formed by said charge movement duct and said feed duct.

14. The engine cylinder according to claim 1, further comprising at least one ignition unit projecting into said combustion chamber being disposed in said cylinder head.

15. The engine cylinder according to claim 1,
wherein said inlet valve is one of a plurality of inlet valves having valve seats; and
further comprising a dividing wall formed between said adjacent two ducts and extending from a portion of said ducts close to a cylinder and between adjacent said valves or said valve seats to a bore or bearing of said pivot axis of said common throttle valve.

16. The engine cylinder according to claim 15, wherein said dividing wall has an end portion remote from the cylinder and is tightly locked to the pivot axis or is in close contact with it or that the pivot axis is supported in the end portion of the pivot axis.

17. The engine cylinder according to claim 1, wherein said common throttle valve is formed as an oval plate.

18. The engine cylinder according to claim 15, wherein said common throttle valve is a plate having a central portion selected from the group consisting of a rectangular central portion and a square central portion, adjoined on each opposite side by a portion formed as an element selected from the group consisting of a semicircle element, a semi-ellipse element and a half-oval element.

19. The engine cylinder according to claim 18, wherein said common throttle valve has a pivot axis extending along a shorter central axis of said common throttle valve and/or perpendicular to exposed sides of said central portion and/or is aligned parallel to a plane of said dividing wall and perpendicular to a length in a portion close to the pivot axis.

20. The engine cylinder according to claim 5, wherein said common throttle valve tightly seals said two ducts when in a closed position, an idle position or in a position for minimum partial load.

21. The engine cylinder according to claim 20, wherein said induction duct has supporting steps for peripheral portions of said common throttle valve formed along a circumference of said induction duct in a initial portion adjacent said two ducts close to said common throttle valve.

22. The engine cylinder according to claim 5, wherein said toroidal formation of said inner wall surface extends over an angle range of no greater than 40° starting from a plane defined through the closed position of said common throttle valve, wherein a apex of the angle lies on said pivot axis.

23. The engine cylinder according to claim 1, wherein a longitudinal axis of said common throttle valve corresponds to a maximum overall extent of valve openings of valves of said ducts, possibly increased by no more than 10%, and a transverse axis of said common throttle valve corresponds to an internal diameter of a valve seat ring, possibly increased by no more than 10%.

24. The engine cylinder according to claim 5, wherein at least one of inner wall surfaces of said ducts or said inner wall surface of said induction duct in proximity to said common throttle valve, apart from a formation, have generatrices that are parallel within and/or between them.

25. The engine cylinder according to claim 1, further comprising:
a valve seat ring; and
an idle air duct opening into in said charge movement duct between said common throttle valve and said valve seat ring and opens in a region of 0 to 35%, of a distance above said valve seat ring and is led to said valve seat ring or is in contact with it on a cylinder side.

26. The engine cylinder according to claim 11, further comprising an injection unit opening into said charge movement duct and containing a fan nozzle, with which fuel is injected in a fan shape through a valve gap of said inlet valve for closing said charge movement duct into a cylinder in a region being disposed underneath an ignition unit disposed in said cylinder head in a central portion of a cylinder bore.

27. The engine cylinder according to claim 26, wherein a plane of injection of the fan-shaped fuel jets is intersected by a jet of combustion air flowing in through said idle air duct.

28. The engine cylinder according to claim 1, further comprising:
a valve seat ring; and
an injection unit disposed in or opening into said charge movement duct between said common throttle valve in the closed position and said valve seat ring in a range from 5 to 30% of a distance above said valve seat ring.

29. The engine cylinder according to claim 11, wherein said idle air duct has an opening formed therein with an area greater by 50 to 100% than an area of openings of idle air ducts for cylinders of equal volume and/or equal performance.

30. The engine cylinder according to claim 11, further comprising an idle air regulator connected before said idle air duct and only one idle air duct is provided or formed for each cylinder.

31. The engine cylinder according to claim 5, further comprising a fuel injection unit remote from the engine cylinder opens into said induction duct, with which fuel can be injected in a controlled manner into an initial portion of said feed duct and/or said charge movement duct close to said common throttle valve.

32. The engine cylinder according to claim 30, wherein said idle air regulator, with said common throttle valve open at an angle of 30 to 90°, sets a flow through said opening of said idle air duct to a predefined, minimal, non-zero through flow value.

33. The engine cylinder according to claim 5, wherein said pivot angle A is 0<A≦35°.

34. The engine cylinder according to claim 12, wherein said peripheral portions are rounded in a shape selected from the group consisting of semi-elliptically, semi-circularly, and half-ovally.

35. The engine cylinder according to claim 1, wherein said common throttle valve in a closed position, over an entire circumference or an entire circumference of portions, contacts wall surfaces formed by said charge movement duct and said feed duct in a gas-tight manner.

36. The engine cylinder according to claim 22, wherein said toroidal formation of said inner wall surface extends over said angle range of no greater than 35°.

37. The engine cylinder according to claim 1, further comprising:
valve seat ring; and
an idle air duct, an opening of said idle air duct in said charge movement duct between said common throttle valve and said valve seat ring is formed in a region of 0 to 30%, of a distance above said valve seat ring and is preferably led to said valve seat ring or is in contact with it on a cylinder side.

38. The engine cylinder according to claim 20, wherein said induction duct has supporting steps for an entire peripheral portion of said common throttle valve formed along a circumference of said induction duct in a initial portion adjacent said two ducts close to said common throttle valve.

39. The engine cylinder according to claim 1, further comprising:
a valve seat ring; and
an injection unit disposed in or opening into said charge movement duct between said common throttle valve in the closed position and said valve seat ring in a range from 10 to 20% of a distance above said valve seat ring.

40. An internal combustion engine, comprising:
at least one engine cylinder, containing:
a cylinder head having a combustion chamber;
an inlet valve disposed in said cylinder head;
a common throttle valve; and
two ducts including a feed duct and a charge movement duct running adjacent to said feed duct to said inlet valve in said cylinder head of the engine cylinder, a through flow of said two ducts being regulated by said common throttle valve extending in or over said two ducts or in or over inflow openings of said two ducts, with which end portions of said two ducts remote from said combustion chamber or said inflow openings of said two ducts can be closed.
